(19) United States
(12) Patent Application Publication
(10) Pub. No.: US 2025/0196514 A1
(43) Pub. Date: Jun. 19, 2025

(54) RECORDING APPARATUS

(71) Applicant: CANON KABUSHIKI KAISHA, Tokyo (JP)

(72) Inventors: SHIN GENTA, Kanagawa (JP); SATOSHI WADA, Tokyo (JP); HAJIME NAGAI, Kanagawa (JP); AYUMI YASUDA, Kanagawa (JP); SHINGO NISHIOKA, Kanagawa (JP); KEIJI KURIYAMA, Saitama (JP); SERENA SAITO, Kanagawa (JP)

(21) Appl. No.: 18/956,547

(22) Filed: Nov. 22, 2024

(30) Foreign Application Priority Data
Dec. 18, 2023 (JP) 2023-212794

(51) Int. Cl. B41J 11/00; B41J 11/66; B41J 11/70; B41J 15/04; B41J 15/16; B41J 29/00

(52) U.S. Cl. CPC B41J 11/00222; B41J 11/663; B41J 11/706; B41J 15/04; B41J 15/16; B41J 29/00

(57) ABSTRACT

A recording apparatus includes a conveying portion, a recording portion, a fixing portion, a cutting portion disposed on the downstream side of the fixing portion in a conveyance direction, an air blowing portion that blows air from an upstream side to the downstream side in the conveyance direction and toward the recording surface of the recording medium, and a control portion that controls an amount of the air from the air blowing portion. The control portion controls an amount of the air blown from the air blowing portion per unit time after the fixing of the image by the fixing portion is ended till a cutting operation performed by the cutting portion to be larger than an amount of the air blown from the air blowing portion per unit time during a recording operation performed by the recording portion.

### BACKGROUND OF THE INVENTION

### Field of the Invention

The present invention relates to a recording apparatus.

### Description of the Related Art

As a recording apparatus that ejects a liquid such as ink onto a sheet-shaped recording medium to record characters and images, an inkjet recording apparatus has been known. U.S. Pat. No. 9,987,858 discloses a configuration that ejects emulsion ink onto a recording medium and dries and fixes the emulsion ink thereto.

FIG. 12 is a schematic cross-sectional view illustrating a configuration of a recording apparatus 6000 according to a comparative example. During a recording operation, the recording apparatus 6000 supplies ink onto a medium 6002 serving as a recording medium, while causing a head 6004 to perform scanning. The medium 6002 supplied with the ink is conveyed to a fixing unit 6200. In the fixing unit 6200, generated hot air is blown to the medium 6002, an emulsion of the supplied ink is formed into a film, and the ink is fixed onto the media 6002. The recording apparatus 6000 is also provided with a platen air blowing unit 6100 for quickly drying the ink that has been ejected from the head 6004 and landed on the medium 6002. The platen air blowing unit 6100 blows air from an upstream ide of the head 6004 toward a downstream side thereof in a direction of conveyance of the media 6002.

### SUMMARY OF THE INVENTION

In the recording apparatus 6000, a cutter 6400 for cutting the medium 6002 after a fixing operation is ended is provided on a downstream side of the head 6004 in the conveyance direction. The cutter 6400 performs scanning in a direction perpendicular to the conveyance direction to cut the medium 6002. However, when the medium 6002 is a heat-sensitive recording medium such as cloth paper, a clear film, or vinyl, the fixing operation raises a temperature of the medium 6002 to soften the medium 6002. When the medium 6002 thus softened is to be cut immediately after the fixing operation, there is a risk that the medium 6002 may bend and may not be able to be cut in a straight line. In addition, since the medium 6002 has been softened by heat, there is also a risk that the cutter 6400 may not be able to penetrate the medium 6002 and cut the medium 6002.

The present invention has been achieved in view of the problem described above, and an object thereof is to provide a recording apparatus that can appropriately cut a medium.

To attain the object described above, a recording apparatus of the present invention includes: a conveying portion that conveys a recording medium in a conveyance direction; a recording portion that ejects a liquid onto a recording surface of the recording medium to record an image; a fixing portion disposed on a downstream side of the recording portion in the conveyance direction to heat and fix the image onto the recording surface; a cutting portion disposed on the downstream side of the fixing portion in the conveyance direction to cut the recording medium; an air blowing portion that blows air from an upstream side to the downstream side in the conveyance direction and toward the recording surface of the recording medium; and a control portion that controls an amount of the air from the air blowing portion, the control portion controlling an amount of the air blown from the air blowing portion per unit time after a fixing of the image by the fixing portion is ended till a cutting operation performed by the cutting portion to be larger than an amount of the air blown from the air blowing portion per unit time during a recording operation performed by the recording portion.

To attain the object described above, a recording apparatus of the present invention includes: a conveying portion that conveys a recording medium in a conveyance direction; a recording portion that ejects a liquid onto a recording surface of the recording medium to record an image; a fixing portion disposed on a downstream side of the recording portion in the conveyance direction to heat and fix the image onto the recording surface, the fixing portion having an opening through which the recording medium after a fixing of the image thereto is ended is to pass; a cutting portion disposed on the downstream side of the fixing portion in the conveyance direction to cut the recording medium; an air blowing portion that blows air from an upstream side to the downstream side in the conveyance direction and toward the recording surface of the recording medium; and a control portion that controls an amount of the air from the air blowing portion, wherein an aperture area of the opening of the fixing portion is equal to a first area during the fixing of the image and is equal to a second area larger than the first area during a period after the fixing of the image is ended till a cutting operation performed by the cutting portion.

According to the present invention, it is possible to provide a recording apparatus that can appropriately cut a medium.

Further features of the present invention will become apparent from the following description of exemplary embodiments with reference to the attached drawings.

### BRIEF DESCRIPTION OF THE DRAWINGS

FIG. 1 is a schematic cross-sectional view illustrating a configuration of a recording apparatus according to a first embodiment;

FIGS. 2A and 2B are schematic front views each illustrating an opening of a fixing unit according to the first embodiment;

FIG. 3 is a perspective view illustrating a configuration of a cutter according to the first embodiment;

FIG. 4 is a plan view illustrating a configuration of a peripheral portion of the cutter according to the first embodiment;

FIG. 5 is a block diagram illustrating a configuration of a control system of the recording apparatus according to the first embodiment;

FIG. 6 is a temperature table showing an appropriate cutting temperature according to the first embodiment;

FIG. 7 is a flow chart of a printing operation according to the first embodiment;

FIG. 8 is a schematic cross-sectional view illustrating a recording apparatus during cooling of a medium according to the first embodiment;

FIG. 9 is a table showing a temperature of the medium at each elapsed time according to the first embodiment;

FIG. 10 is a flow chart illustrating a cutting process in a second embodiment;

FIG. 11 is a schematic cross-sectional view illustrating a configuration of a recording apparatus according to the second embodiment; and

FIG. 12 is a schematic cross-sectional view illustrating a configuration of a recording apparatus according to a comparative example.

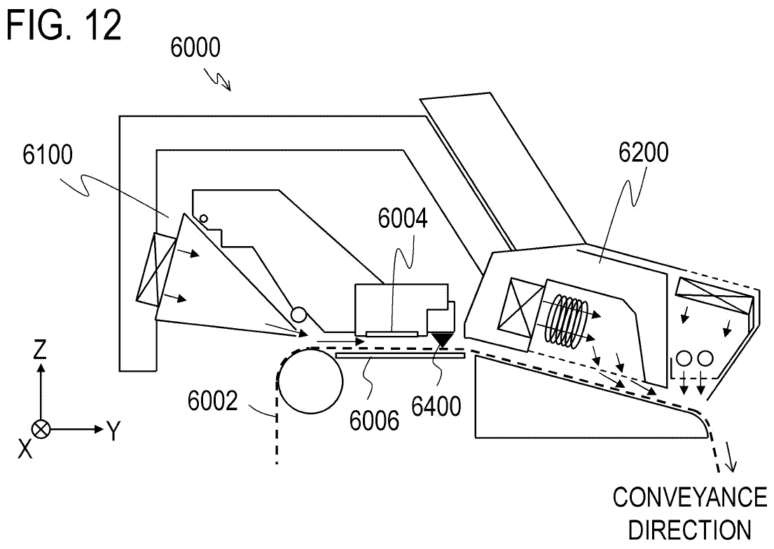

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

In addition, in the following embodiments, a plurality of features are described, but not all of the plurality of features are essential to the present invention. The plurality of the features may also be optionally combined with each other. Furthermore, in the accompanying drawings, the same or like components are denoted by the same reference numerals, and redundant description thereof is omitted.

### First Embodiment

### Overall Configuration

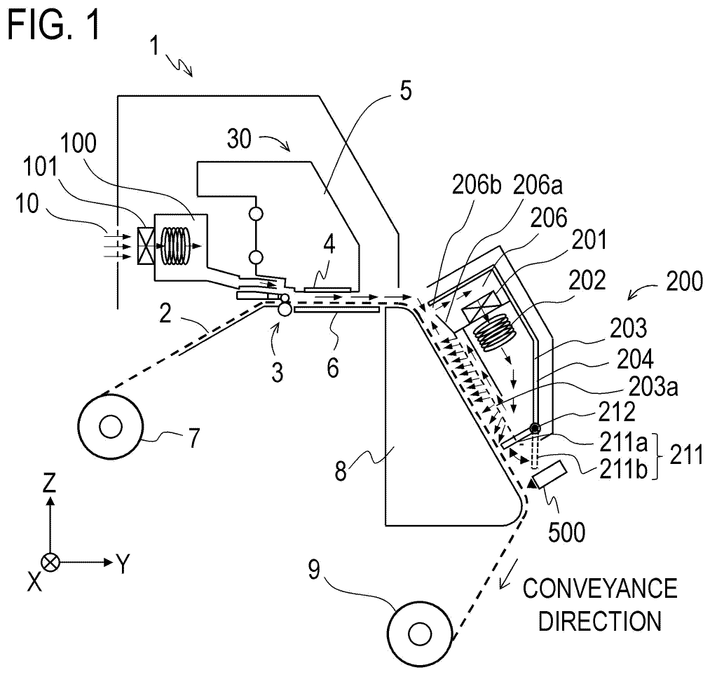

Referring first to FIG. 1, a configuration of a recording apparatus 1 according to a first embodiment of the present invention will be described. FIG. 1 is a schematic cross-sectional view illustrating the configuration of the recording apparatus 1. The recording apparatus 1 is an inkjet printer that performs printing by using an inkjet method, and ejects a liquid such as ink onto a medium 2 to record an image on a surface of the medium 2. The recording apparatus 1 is a printer that ejects emulsion ink but, in applying the present invention, an ink type is not limited.

Note that the term “recording” includes not only forming significant information, such as characters or graphics, but also forming an image, design, a pattern, or the like on a recording medium or processing the medium in a broader sense regardless of whether the information is significant or insignificant, and it does not matter whether or not records are clearly visualized so as to be visually perceptible by a human.

Additionally, the term “ink” should also be interpreted in a broader sense in the same manner as in the foregoing definition of the term “recording”. Therefore, the term “ink” refers to a liquid which can be used to form an image, design, a pattern, or the like, process a medium, or perform ink processing (e.g., solidification or insolubilization of a coloring material in the ink to be supplied onto the medium).

FIG. 1 illustrates conveyance of the medium 2 along a conveyance path inside the recording apparatus 1. Examples of the medium 2 that can be used include an ink absorbent medium such as paper and an ink non-absorbent medium such as vinyl chloride. Details of the medium 2 will be described later.

The recording apparatus 1 includes a conveying unit 3 serving as a conveying portion that conveys the medium 2. The conveying unit 3 is configured to include a plurality rollers, a paper discharge guide 8, and the like and, in FIG. 1, as representative components of the conveying unit 3, a pinch roller and a LF roller are illustrated.

The recording apparatus 1 includes a paper feeding roll 7 serving as a feeding portion that allows the medium 2 to be wound therearound into a roll shape and feeds the medium 2 and a wind-up roll 9 serving as a wind-up portion that allows the medium 2 to be wound therearound into a roll shape and winds up the medium 2. The recording apparatus 1 uses a so-called roll-to-roll method in which the medium 2 is wound around the paper feeding roll 7 before printing and is wound around the wind-up roll 9 after the printing. However, a method of conveying the medium 2 is not limited thereto and, e.g., a method which conveys a cut paper sheet and performs printing thereon may also be used.

The recording apparatus 1 includes a recording unit 30 serving as a recording portion configured to include a head 4 which is a liquid ejecting head, a carriage 5 that holds the head 4, and a platen 6 disposed to face a scan region of each of the head 4 and the carriage 5. The recording unit 30 ejects ink not shown from the head 4 and supplies the ink onto the medium 2, while causing the carriage 5 to perform scanning together with the head 4 in a direction perpendicular to a direction of conveyance of the medium 2. At that time, the conveying unit 3 continuously conveys the medium 2 in the conveyance direction to form an image in a plane of the medium 2.

In a state where the medium 2 is supported by the platen 6 from below, the ink is ejected from the head 4. The following description will be given on the assumption that a direction of the scanning by the head 4 (carriage 5) is an X-direction, the conveyance direction of the medium 2 at a position facing the head 4 is a Y-direction, and a vertical direction (gravity direction) is a Z-direction.

The recording apparatus 1 includes a platen air blowing unit 100 having an air blowing fan 101. The platen air blowing unit 100 retrieves outside air 10, which is air outside the recording apparatus 1, and uses the air blowing fan 101 to blow the air onto the surface of the medium 2 on the platen 6. This can accelerate evaporation of moisture contained in the ink ejected onto the surface of the medium 2 on the platen 6 and accelerate fixing of the ink. In addition, it is possible to remove ink mist that has been ejected from the head 4 and has not been landed on the medium 2.

After a plurality of printing jobs are performed by using the roll paper, printing is continuously performed on the medium 2, and consequently the printing and drying is continuously and repeatedly performed. Meanwhile, since 1-job printing is performed on one cut paper sheet, each of the printing and drying is performed only once. When the carriage 5 moves to an end of a recording region on the medium 2, the conveying unit 3 conveys a given amount of the medium 2 to move a region to be subsequently conveyed to a position where the head 4 can perform recording. By repeating the foregoing operation, an image is recorded.

The medium 2 on which the image has been recorded by the recording portion is conveyed to a fixing unit 200 serving as a fixing portion. In the fixing unit 200, heat is applied to the medium 2, and the ink is hardened and fixed onto the medium 2. The medium 2 with the ink fixed on a surface thereof is discharged from the fixing unit 200 and wound up by the wind-up roll 9. After the fixing, when a cutting process is necessary, the cutting process is performed on the medium 2 with a cutter 500 serving as a cutting portion.

### Fixing Configuration

Next, a description will be given of a configuration of the fixing unit 200. The fixing unit 200 is the fixing portion that dries and fixes the ink supplied to the medium 2. The fixing unit 200 is substantially box-shaped, and a bottom surface thereof faces a conveying surface of the medium 2. Hot air is blown from the bottom surface toward the medium 2 to raise temperatures of the ink and the medium 2, evaporate water and a solvent each contained in the ink, and form an emulsion into a film.

The fixing unit 200 according to the first embodiment is configured to include fans 201, heaters 202, a chamber 203, and a heat insulating material 204. The fans 201 are provided on a side surface of the chamber 203 forming an outer wall of the fixing unit 200. Air is blown from each of the fans 201 toward the inside of the chamber 203 to be heated by the heaters 202 in the chamber 203 to generate hot air. Then, the generated hot air is guided to the medium 2 in the chamber 203 and blown from a chamber bottom surface 203a facing the medium 2 toward the medium 2.

As the heaters 202 each serving as a heating source, e.g., a heater in which an open-coil nichrome wire is held by a mica or an insulator not shown or a sheathed heater can be used. The heaters 202 are arranged to be spaced apart from a surface forming the chamber 203 and are paired with each other so as to allow air blown from the fans 201 to directly hit the heaters 202. The plurality of pairs of the fans 201 and the plurality of pairs of the heaters 202 are provided in a width direction of the recording apparatus 1, i.e., the X-direction. Around an outer periphery of the chamber 203, the insulating material is provided and, even when the chamber 203 is heated by the generated hot air to a high temperature, an outer periphery of the insulating material 204 is inhibited from reaching a high temperature. An outer casing 205 of the fixing unit 200 is provided around the outer periphery of the insulating material 204.

A part of the hot air blown from the chamber bottom surface 203a toward the medium 2 is exhausted, while another part thereof is collected to the fans 201. Note that the chamber bottom surface 203a is a surface facing a recording surface of the medium 2. In the fixing unit 200, an air intake portion 206 is provided to mix the collected hot air with outside air and blow the resulting air into the chamber 203. The air intake portion 206 is provided with an air intake portion opening 206a, and the hot air and the outside air are taken in through the air intake portion opening 206a. The mixed hot air is blown from the fans 201 into the chamber 203 and circulated and heated by the heaters 202. Around an outer periphery of the air intake portion 206 also, the insulating material 204 is provided in the same manner as around the outer periphery of the chamber 203. Note that, in the conveyance direction of the medium 2, the air intake portion 206 is located in an upstream-side portion of the fixing unit 200.

The recording apparatus 1 includes the paper discharge guide 8 serving as a paper passing surface of the medium 2. The paper discharge guide 8 is a guide member that guides a surface of the conveyed medium 2 which is opposite to the recording surface thereof. The platen 6 is disposed such that a surface thereof on which the medium 2 is to be placed is substantially horizontal. To reduce a size of the recording apparatus 1, the entire fixing unit 200 including the paper discharge guide 8 is obliquely placed. In other words, a surface of the paper discharge guide 8 which guides the medium 2 extends in a direction crossing the surface of the platen 6 on which the medium 2 is to be placed. A portion of the paper discharge guide 8 located on the platen 6 side is substantially provided with a curvature in consideration of a paper passing property.

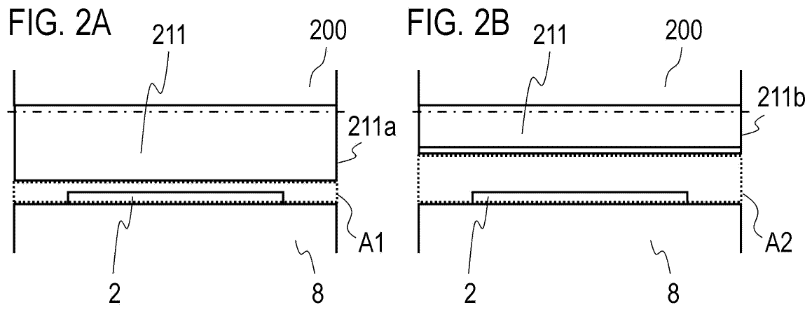

In the conveyance direction of the medium 2, a downstream-side end portion of the fixing unit 200 is formed with an opening through which the recording medium can pass. The opening is a part of a space between the fixing unit 200 and the paper discharge guide 8. FIGS. 2A and 2B are schematic front views illustrating the opening of the fixing unit 200, which are views when the opening is viewed in the conveyance direction of the medium 2 passing between the fixing unit 200 and the paper discharge guide 8. In the first embodiment, the fixing unit 200 is configured such that an aperture area of the opening is changeable to a first area A1 and to a second area A2 larger than the first area.

In the conveyance direction of the medium 2, a downstream-side end portion of the fixing unit 200 is provided with a flap 211. The flap 211 is a plate-shaped moving member configured to be pivotable around a pivot point 212 used as a center axis. The flap 211 is formed such that a width of the recording apparatus 1 in the width direction, i.e., the X-direction is substantially equal to a width of the fixing unit 200.

The flap 211 is configured to be displaceable to two positions which are a first position (closing position 211a) that closes the downstream-side opening of the fixing unit 200 and a second position (opening position 211b) that opens the downstream-side opening. Note that, when the flap 211 is at the closing position 211a, a space at the downstream-side end portion of the fixing unit 200 is not completely closed, and an opening through which the medium 2 can pass is at least open between the fixing unit 200 and the paper discharge guide 8.

As illustrated in FIG. 2A, when the flap 211 is located at the closing position 211a, the aperture area of the opening of the fixing unit 200 is equal to the first area A1. Meanwhile, as illustrated in FIG. 2B, when the flap 211 is located at the opening position 211b, the aperture area of the opening of the fixing unit 200 is equal to the second area A2. The aperture area of the opening of the fixing unit 200 mentioned herein is an area occupied by the opening between the fixing unit 200 and the paper discharge guide 8 at the downstream-side end portion of the fixing unit 200 when the opening is viewed in the conveyance direction of the medium 2.

Note that, in the present embodiment, a description will be given on the assumption that the aperture area of the opening of the fixing unit 200 is changed by the pivoting of the flap 211, but it may also be possible to use a configuration using a shutter instead of the flap 211. In other words, the aperture area of the opening of the fixing unit 200 may be changed by performing sliding movement in a direction having a component of a direction perpendicular to the paper discharge guide 8. Alternatively, the aperture area may also be changed by opening and closing of a portion of a member provided in the opening of the fixing unit 200.

### Cutter Configuration

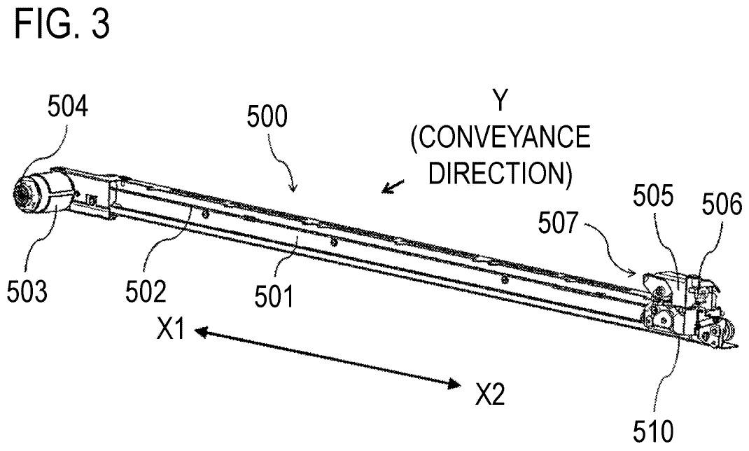

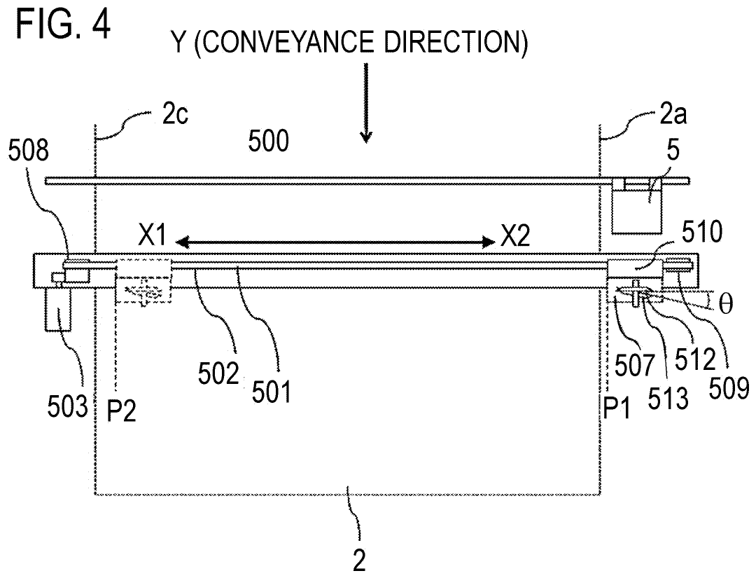

Next, a description will be given of a configuration of the cutter 500. FIG. 3 is a perspective view illustrating the configuration of the cutter 500. FIG. 4 is a plan view illustrating a configuration of a peripheral portion of the cutter 500.

The cutter 500 is a cutting portion (cutting unit) configured to include a guide rail 501, a toothed belt 502, a carriage 510, and a cutter unit 507. The guide rail 501 reciprocably guides the carriage 510 along the direction (X-direction) crossing the conveyance direction (Y-direction) of the sheet-shaped medium 2. In the first embodiment, the carriage 510 is reciprocably guided in the X-direction perpendicular to the Y-direction that is the conveyance direction of the medium 2. As indicated by an arrow in FIG. 3, in the following description, it is assumed that one way in the X-direction is an X1-direction, while another way opposite to the X1-direction is an X2-direction, and the X1-direction and the X2-direction may be distinguished from each other as required.

The carriage 510 is connected to the belt 502. At a one-side (X1-direction-side) end portion of the guide rail 501 in a longitudinal direction, a cutter motor 503 and a motor pulley 508 are provided. Meanwhile, at an another-side (X2-direction-side) end portion of the guide rail 501 in the longitudinal direction, a tensioner pulley 509 and a tensioner spring (not shown) are provided. The belt 502 is stretched between the motor pulley 508 and the tensioner pulley 509. As a result of biasing of the tensioner pulley 509 by the tensioner spring in the X2-direction, a tension is applied to the belt 502 to prevent jumping of the belt 502.

The cutter unit 507 is replaceably connected to the carriage 510 in a predetermined connecting direction, and is configured to be able to perform scanning in the X-direction. The cutter unit 507 has an upper movable blade 512 and a lower movable blade 513 each disc-shaped and capable of cutting the medium 2. The upper movable blade 512 and the lower movable blade 513 are arranged so as to cross each other at a predetermined amount of angle θ (crossing angle), as illustrated in FIG. 4 and, at a contact point therebetween, the medium 2 is cut. In the first embodiment, the upper movable blade 512 is disposed substantially parallel to the X1-direction that is a cutting direction, while the lower movable blade 513 is disposed to cross the X1-direction.

The cutter unit 507 reciprocates in the X1- and X2-directions and cuts the medium 2 when moving in the X1-direction. Each of the upper movable blade 512 and the lower movable blade 513 of the cutter unit 507 is a disc-shaped blade having the blade provided around an outer peripheral portion thereof, which is rotatably supported. The carriage 510 gains a rotary force from relative movement between the carriage 510 and the belt 502 and drives the upper movable blade 512 of the cutter unit 507 to rotate with the rotary force. As a result, during cutting of the medium 2, each of the lower movable blade 513 and the upper movable blade 512 in contact therewith rotates.

During an operation of recording an image, the cutter unit 507 stands by at a standby position P1 outside an end portion 2a of the medium 2 and, during the cutting of the medium 2, the cutter unit 507 moves from the standby position P1 in the X1-direction that is the cutting direction. After the cutting of the medium 2, the cutter unit 507 is reversed at a reverse position P2 corresponding to the width of the medium 2, and returns to the standby position P1 for the subsequent cutting operation to stand by. The movement of the cutter unit 507 in the X2-direction does not contribute to the cutting operation.

A moving position of the cutter unit 507 in the X-direction can be controlled on the basis of an output signal (pulse signal) from an encoder (not shown) included in the cutter motor 503. By preliminarily recognizing a relationship between a pulse number of an encoder 504 and an amount of movement of the cutter unit 507 and counting the pulse number of the encoder 504, it is possible to acquire the amount of movement of the cutter unit 507.

To a fixed position in the vicinity of the standby position P1 of the cutter unit 507 during a non-cutting period, a sensor holder 505 is fixed. The sensor holder 505 holds a standby position sensor 506. By sensing a sensor flag portion (not shown) provided in the cutter unit 507 with the standby position sensor 506, it is possible to precisely stop the cutter unit 507 at the standby position P1. With the standby position sensor 506, it is also possible to sense the presence or absence of the cutter unit 507 at the standby position P1.

### Medium

In the present application, the term “medium” refers to not only paper used in a typical recording apparatus, but also a material capable of receiving ink such as cloth, a plastic film, a metal plate, glass, a ceramic, a resin, wood, or leather. In particular, a “non-permeable medium/low-permeability medium” is a “non-absorbent medium/low-absorbency medium”. Examples of the non-permeable medium include those that are not produced as media for aqueous inkjet ink, such as glass, plastic, film, and YUPO paper. Examples of the non-permeable medium also include those that are not subjected to surface treatment for inkjet printing such as coating of a surface of such a base material as a plastic film or paper with plastic (i.e., those on which ink absorbing layers are not formed). Examples of the plastic include polyvinyl chloride, polyethylene terephthalate, polycarbonate, polystyrene, polyurethane, polyethylene, polypropylene, and the like. Specific examples of the low-permeability medium include media such as printing paper to be used in offset printing or the like, such as art paper and coating paper.

A description will be given of printing paper having an extremely low permeability with respect to aqueous ink (hardly absorbing medium) compared to that of inkjet paper. The printing paper refers to authenticated (authentic) printing paper when the printing paper is actually used for real printing in offset printing to produce a product (commercial product). Paper made of pulp as a raw material and used in an original state thereof is uncoated paper, while paper having a surface smoothly coated with a white pigment or the like is coated paper. In inkjet recording, on the coated paper, an image defect due to ink overflow and a drying defect are more evident. A coating layer is obtained by applying a mixed paint containing a sizing agent (such as a synthetic resin) that limits a liquid absorbency of a gap between pulps and prevents bleeding of a water-based pen, a filler (such as kaolin) that improves opacity, whiteness, smoothness, and the like, and a paper strengthening agent (such as starch) at a rate of several grams/m² to 40 grams/m². An average radius of capillary pores in the coated paper is normally distributed around about 0.06 μm, and a large number of capillary tubes allow moisture to permeate the coated paper (capillarity). However, a pore volume of the printing paper is significantly lower than that of the inkjet paper, and accordingly the permeability with respect to aqueous ink is low and the ink overflows at a surface of the paper to result in a significant image defect and a significant drying defect.

A description will be given of a vinyl chloride sheet that has no permeability with respect to aqueous ink, in comparison with the inkjet paper. The vinyl chloride sheet is a soft sheet manufactured by adding a plasticizer to a vinyl chloride resin as a main raw material, which has excellent printability and embossability (convex and concave patterning through die-stamping) in gravure printing, screen printing, or the like. A combination of these allows a variety of expressions, and therefore the vinyl chloride sheets are used in a large number of products such as tarpaulin, canvas, and wall paper. However, since the main raw material of the vinyl chloride sheet is the vinyl chloride resin, the vinyl chloride sheet has no permeability with respect to aqueous ink and the ink overflows at the surface of the paper to result in a significant image defect and a significant drying defect.

Other examples of the printing paper include those that are not produced as media for aqueous inkjet ink, such as glass, plastic, film, and YUPO paper. Still other examples of the printing paper include those that are not subjected to surface treatment for inkjet printing such as coating of a surface of such a base material as a plastic film or paper with plastic (i.e., those on which ink absorbing layers are not formed). Examples of the plastic include polyvinyl chloride, polyethylene terephthalate, polycarbonate, polystyrene, polyurethane, polyethylene, polypropylene, and the like.

### Data Processing Step

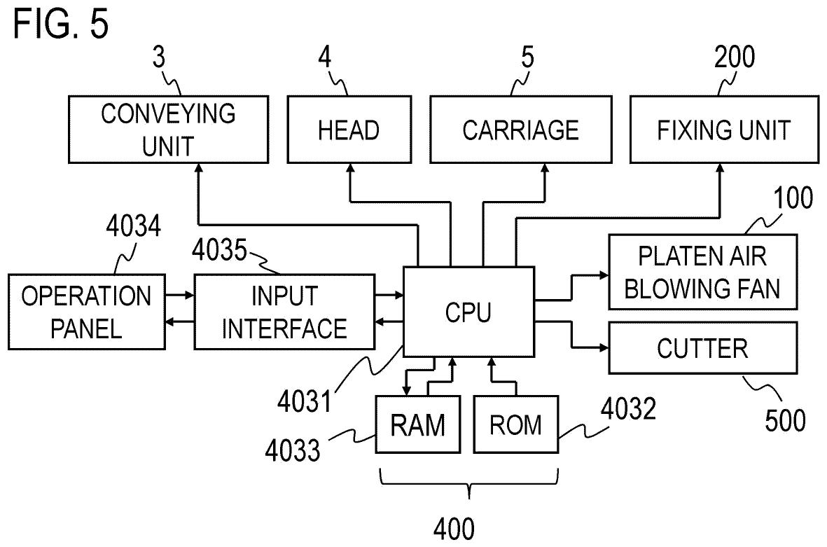

FIG. 5 is a block diagram for illustrating a configuration of a control system of the recording apparatus 1. A control portion 400 of the recording apparatus 1 is configured to include a CPU 4031, a ROM 4032, and a RAM 4033. The CPU 4031 controls each of the portions of the recording apparatus 1 including the carriage 5, the conveying unit 3, the head 4, the fixing unit 200, the platen air blowing unit 100, and the cutter 500 according to a control program stored in the ROM 4032. To the CPU 4031, various set information such as a type and a width of a medium, a set temperature of the fixing unit, and the presence or absence of cutting of the medium, and the like are input from an operation panel 4034 via an input interface 4035. The CPU 4031 also writes and reads a set amount of air or the like to and from the RAM 4033. Note that the configuration of the control system illustrated in FIG. 5 is only exemplary, and the control system is not limited to such a configuration.

### Appropriate Cutting Temperature

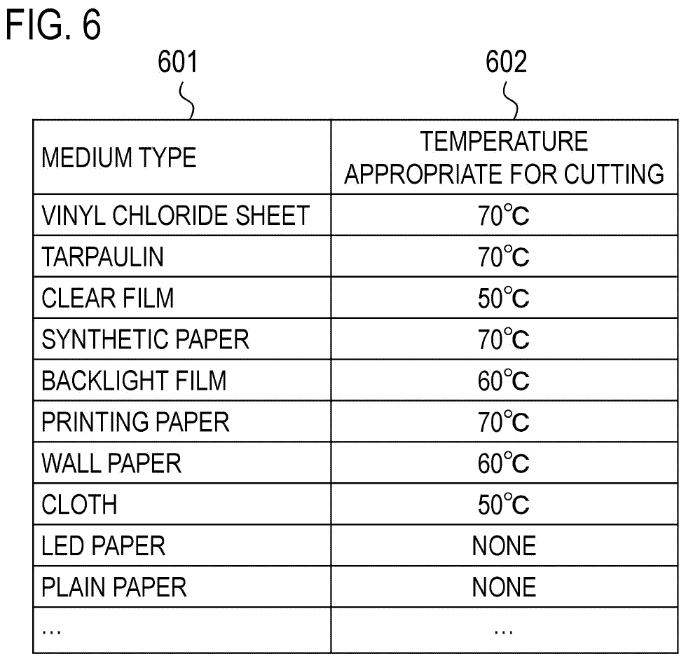

FIG. 6 is a temperature table showing a maximum temperature appropriate for cutting each of medium types in the first embodiment. In a column 601 of the temperature table, all the medium types supported by the recording apparatus 1 are registered. Meanwhile, in a column 602 of the temperature table, an appropriate cutting temperature Ta which is a maximum temperature appropriate for cutting each of the medium types is registered. When the temperature of the medium 2 is not more than the appropriate cutting temperature Ta, the medium 2 can normally be cut, and a probability of occurrence of a cutting failure is low. For the medium type that can be cut at any temperature, the appropriate cutting temperature Ta is not set. Note that the medium types and the appropriate cutting temperature Ta in the temperature table shown in FIG. 6 are only exemplary, and can be changed as appropriate according to the configurations and the like of the fixing unit 200 and the cutter 500.

For example, after passing through the fixing unit 200, the media particularly susceptible to heat, such as cloth paper and a clear film, are heated by the hot air from the fixing unit 200 to higher temperatures to be softened. When these media are to be cut in a state after the fixing where the temperatures are high, the media bend and cannot be cut in straight lines. Alternatively, since the media are softened by heat, the cutter 500 cannot penetrate the media. To prevent such a cutting failure, it is ideal that temperatures of these media immediately before cutting are lower than the appropriate cutting temperatures Ta.

### Cutting Process Step

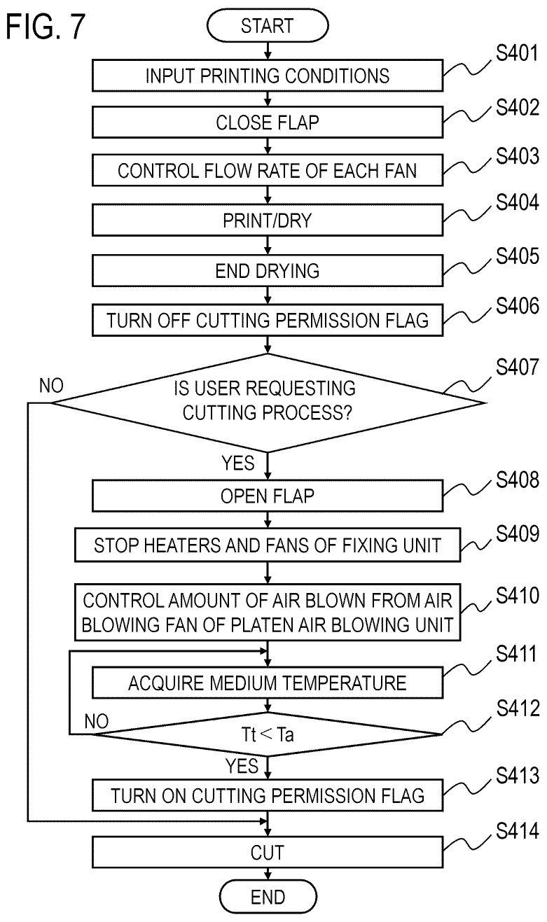

Next, a description will be given of a cutting process step performed by the recording apparatus 1. FIG. 7 is a flow chart illustrating a sequential printing operation including the recording operation and the cutting operation according to the first embodiment. Referring to FIG. 7, a detailed description will be given below of the printing operation along the flow chart.

Processing S401 is a step of inputting printing conditions. In the processing S401, a user transmits a medium type to be printed by the recording apparatus 1 and image information, and such information items are stored in the recording apparatus 1. After the inputting of the printing conditions, the present flow advances to processing S402. The information transmission is performed by the user via the operation panel 4034 or an external apparatus.

The processing S402 is a step of moving the flap 211 to the closing position 211a. As described previously, the part of the hot air blown from the fixing unit 200 onto the medium 2 is exhausted to the outside of the fixing unit 200, while the remaining hot air is collected by the fans 201. To increase efficiency of the heating of the medium 2, it is desirable to reduce an amount of the hot air exhausted to the outside of the fixing unit 200 and increase an amount of the collection by the fans 201. Accordingly, it is desirable to bring the flap 211 into a closed state prior to a fixing processing step and minimize the amount of the hot air exhausted to the outside of the fixing unit 200. After the movement of the flap 211 to the closing position 211a that brings the flap 211 into the closed state, the present flow advances to processing S403.

The processing S403 is a step of controlling a flow rate of each of the fans. According to the information in the processing S401 of inputting the printing conditions, the flow rate of each of the fans 201 of the fixing unit 200 and the flow rate of the air blowing fan 101 of the platen air blowing unit 100 are controlled, and the present flow advances to processing S404. Note that, in the step S401 of inputting the printing conditions, it may also be possible to store medium information according to the type of the medium 2 input by the user and simultaneously perform the same fan flow rate control as that in the processing S403 according to the stored medium information. At that time, the flow rate of the air blowing fan 101 of the platen air blowing unit 100 is also simultaneously controlled.

Processing S404 is a step of recording and drying an image. In the processing S404 performed herein, the image information transmitted in the step S401 of inputting the printing conditions is stored in the medium 2 by the recording unit 30, and then the medium 2 is dried by the fixing unit 200. At this time, the fans 201 and the air blowing fan 101 operate exactly as controlled in the processing S403. During the recording operation performed by the recording unit 30 and during the fixing operation (during the fixing of the image) performed by the fixing unit 200, the flap 211 is located at the closing position 211a, and the aperture area of the downstream-side opening of the fixing unit 200 is equal to the first area A1.

Processing S405 is a step of ending the drying. The end of the drying refers to a case where, e.g., after the head 4 ends the recording operation on the basis of a job input to the recording apparatus 1, drying is performed on the basis of the image information or the like, and the end of the drying is determined by the CPU 4031. For example, it may also be possible to store a length of an image in the conveyance direction from image data included in the job input to the recording apparatus 1, specify an amount of conveyance of the medium 2 from an amount of driving of the conveying unit 3, and determine that the drying is ended when a rear end (upstream end in the conveyance direction) of the image reaches a downstream end of the fixing unit 200. In a case where it is determined that the drying is ended, the conveyance of the medium 2 by the conveying unit 3 is stopped. In a case where the job including a plurality of the image data sets is received in the processing S401 or where a plurality of the jobs are continuously received, when a rear end of the last image reaches the downstream end of the fixing unit 200, it is determined that the drying is ended, and the conveyance of the medium 2 is stopped.

It is assumed that, in the recording apparatus 1, after the end of the drying, cutting is not automatically performed, and the cutting is performed only in a case where the user requests cutting or during maintenance or the like, but the present flow is not limited thereto. After the drying is ended in the processing S405, the present flow advances to Processing S406. Note that the processing S405 may also be included in the drying step in the processing S404.

The processing S406 is a step of turning OFF a cutting permission flag.

When a cutting instruction is given after the end of the drying, in a case where the cutting permission flag is not ON, the cutting is not basically performed. After the cutting permission flag is turned OFF in the processing S406, the present flow advances to determination S407.

The determination S407 is a step of determining whether or not the user is requesting the cutting operation. In the present determination, the CPU 4031 determines, e.g., whether or not the user has pressed a cut button on the operation panel. However, this is only exemplary, and a determination method is not limited thereto. When YES is given as a result of the determination S407, i.e., when the user is requesting the cutting operation, the present flow advances to Processing S408. When NO is given as a result of the determination S407, i.e., when the user is not requesting the cutting operation, the present flow advances to processing S414 to be ended.

The processing S408 is a step of moving the flap 211 to the opening position 211b. In the processing S408 performed herein, the flap 211 is opened to bring a space on a downstream side of the fixing unit 200 after the end of the drying into an open state. By bringing the flap 211 into an open state, in processing S409 described later, the space between the fixing unit 200 and the paper discharge guide 8 is expanded to increase a cross-sectional area of an airflow path of the platen blown air and increase the flow rate of the air. In other words, during a period after the fixing of the image by the fixing unit 200 till the cutting operation performed by the cutter 500, the flap 211 is located at the opening position 211b, and the aperture area of the downstream-side opening of the fixing unit 200 is equal to the second area A2.

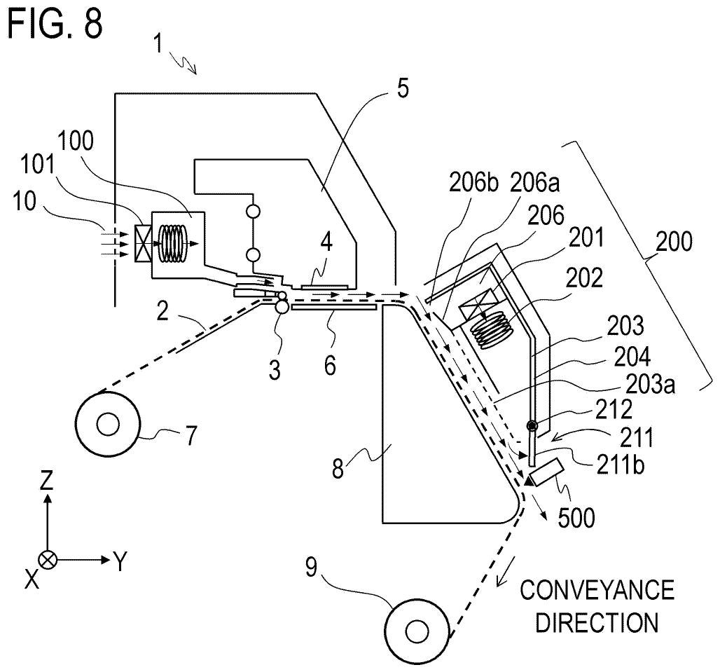

The processing S409 is a step of stopping the heaters 202 and the fans 201 of the fixing unit 200. In the first embodiment, the air blowing fan 101 of the platen air blowing unit 100 continues to be in an ON state, while the heaters 202 and the fans 201 of the fixing unit 200 are turned OFF. Processing S410 is a step of controlling an amount of the air blown from the air blowing fan 101 of the platen air blowing unit 100. In the first embodiment, after the heaters 202 and the fans 201 of the fixing unit 200 are stopped, the amount of the air blown from the air blowing fan 101 is increased to be larger than that during the recording operation. FIG. 8 is a schematic cross-sectional view of the recording apparatus 1 illustrating control of the fan flow rate during the cooling of the medium in the processing S409. As indicated by arrows in FIG. 8, the outside air 10 retrieved from the air blowing fan 101 flows along a flow path formed to extend from the recording unit 30 to the cutter 500 along the conveyance direction of the medium 2.

A more detailed description will be given of a flow of the outside air 10. First, the outside air 10 passes through a space above the medium 2 on the platen 6 which faces the recording surface of the medium 2 (space between the platen 6 and the head 4). The outside air 10 that has passed through the space subsequently passes through a space above the paper discharge guide 8 which faces the recording surface of the medium 2 on the paper discharge guide 8 (space between the fixing unit 200 and the paper discharge guide 8). As a result of generation of such an air flow, hot air in the space between the fixing unit 200 and the medium 2 on the paper discharge guide 8 in which the hot air flows is forcibly exchanged with the outside air 10 and relatively cold air is directly applied onto the medium 2, and the entire medium 2 is thus cooled. In other words, by moving the flap 211 to the opening position 211b, it is possible to more efficiently cool the medium 2.

In the first embodiment, after the fixing (after the end of the drying), an amount of the air blown from the air blowing fan 101 per unit time during the cooling of the medium prior to the cutting is set larger than an amount of the air blown from the air blowing fan 101 per unit time during the recording operation performed by the head 4. For example, when the amount of the air blown from the air blowing fan 101 during the recording operation is set to 3.5 m/see, the amount of the air blown from the air blowing fan 101 during the cooling of the medium is preferably set to about 5 to 6 m/sec. When the cutting operation for the medium 2 is thus performed, the amount of the air blown from the air blowing fan 101 in the processing S410 is increased. With such a configuration, the air in the space between the fixing unit 200 and the paper discharge guide 8 is exchanged with the colder air, and the outside air 10 is applied from the air blowing fan 101 to the medium 2 on the paper discharge guide 8 placed at a position more distant than the platen 6 to allow the medium 2 to be effectively cooled.

Processing S411 is a step of performing calculation processing for acquiring a medium temperature Tt, which is latest temperature information of the medium 2. In the first embodiment, by the processing of the following calculation formula (Expression 1) by the CPU 4031, the medium temperature Tt is acquired. When an in-apparatus temperature is A ° C., a room temperature (environmental temperature) is B ° C., a speed coefficient of the temperature reduction of the medium 2 is c, a period elapsed from the completion of the fixing is t seconds, and the medium temperature Tt after a lapse of t seconds from the completion of the fixing is X ° C., X is given by Expression 1.

$$X = A - ( A - B ) \times c \times t \qquad ( Expression 1 )$$

More specifically, the in-apparatus temperature A ° C. is a temperature in a space between the fixing unit 200 and the medium 2 in which the hot air flows, while the room temperature B ° C. is the outside temperature outside the recording apparatus 1. The in-apparatus temperature A ° C. and the room temperature B ° C. can be acquired by, e.g., a temperature sensor or the like. In the first embodiment, a temperature acquiring means of the medium 2 is configured to include the temperature sensor and the CPU 4031 serving as a calculating means. More preferably, the room temperature B ° C. is calculated herein by acquiring the temperature outside the apparatus by using, e.g., a temperature/humidity sensor or the like, but may also be a constant set in advance. Note that a method of estimating the medium temperature Tt is not limited to that using Expression 1 shown above. For example, it may also be possible to use a configuration in which the medium temperature Tt is directly acquired by the temperature acquiring means such as the temperature sensor.

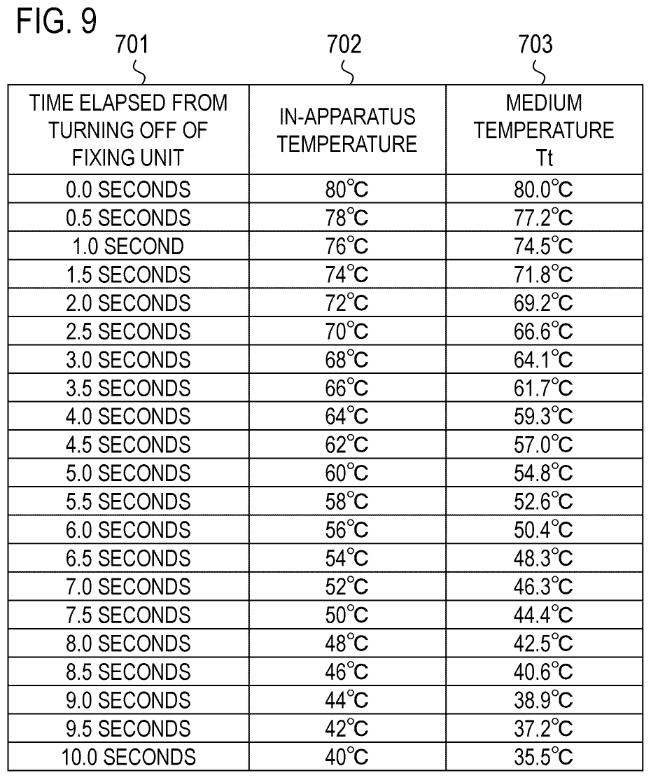

FIG. 9 shows a result of calculating the medium temperature Tt which is an estimated temperature of the medium 2 on the basis of Expression 1 shown above in the first embodiment. FIG. 9 is a table showing the in-apparatus temperature and the medium temperature Tt at each of times elapsed from the turning OFF of the fixing unit 200. The result of calculating the medium temperature Tt illustrated in FIG. 9 is X which is calculated on the basis of Expression 1 shown above on the assumption that the in-apparatus temperature is 80° C., the room temperature is 25° C., and the speed coefficient c of the temperature reduction of the medium 2 is 0.03. A column 701 of the table shown in FIG. 9 indicates the time elapsed from the turning OFF of the fixing unit 200, a column 702 thereof indicates the in-apparatus temperature, and a column 703 thereof indicates the medium temperature Tt.

With the lapse of time, the temperature between the fixing unit 200 and the medium 2 gradually decreased and, accordingly, the medium temperature Tt immediately before the cutting also decreased. In particular, with regard to cloth paper and a clear film each susceptible to a cutting failure, it can be understood that a temperature appropriate for the cutting (not more than 50° C.) is reached around 6.5 seconds.

Determination S412 is a step of determining whether or not the latest medium temperature Tt is a temperature appropriate for the cutting through comparison. In the present determination, the CPU 4031 functions as a determining means, refers to the temperature table (FIG. 6) of the temperature appropriate for cutting of each of the medium types, and compares the medium temperature Tt acquired in the processing S411 to the appropriate cutting temperature Ta. When YES is given as a result of the determination S412, i.e., when the medium temperature Tt is lower than the appropriate cutting temperature Ta, the present flow advances to the processing S413. When NO is given as a result of the determination S412, i.e., when the medium temperature Tt is not less than the appropriate cutting temperature Ta, the present flow returns to the processing S411 to calculate the medium temperature Tt again.

Processing S413 is a step of turning ON the cutting permission flag since the latest medium temperature Tt is lower than the appropriate cutting temperature Ta. Thereafter, when a cutting instruction is given, the cutting can be performed. After the cutting permission flag is turned ON in the processing S413, the present flow advances to processing S414.

The processing S414 is a step of performing the cutting operation on the medium 2 by using the cutter 500. After the cutting of the medium 2 in the processing S414, the present flow is ended. Thus, in the first embodiment, on the basis of the determination result of the determination S412, the cutter 500 is driven to perform the cutting operation on the medium 2.

Note that, in the first embodiment, after the fixing operation (drying) is completely ended, the flap 211 is moved to the opening position 211b, and the fixing unit 200 is switched to an OFF state, but an opening operation for the flap 211 is not limited to such a configuration. For example, it can also be considered to use a configuration which starts the opening operation for the flap 211 in a state where a fixing operation performed by the fixing unit 200 has been completed with respect to a portion of the image formed on the surface of the medium 2 to be subjected to the fixing operation which corresponds to 90% or more thereof. Alternatively, it can also be considered to use a configuration which starts the opening operation for the flap 211 when the fixing operation performed with respect to a portion of the image formed on the surface of the medium 2 exclusive of a 2 mm range from an upstream end thereof in the conveyance direction is completed. This is because, even in a state where a part of the fixing operation is not completed, when the opening operation for the flap 211 is started immediately before the completion of the fixing operation, the fixing operation is completed before the cutting operation for the medium 2 is started, and the cutting operation can be performed in a state where the image has appropriately been fixed to the medium 2. When the opening operation for the flap 211 is thus started in a state where a part of the fixing operation is not completed, the conveyance of the medium 2 is continued, while the opening operation for the flap 211 is performed. Then, when a rear end (upstream end in the conveyance direction) of the last image in the job received in S401 reaches the downstream end of the fixing unit 200, the conveyance of the medium 2 is stopped.

As described above, with the configuration of the first embodiment, after it is determined whether or not the temperature of the medium 2 is appropriate for the cutting operation, the cutting operation is performed, and therefore it is possible to suppress a cutting failure. In addition, since whether or not the cutting operation can be performed is determined according to the type of the medium 2, it is possible to minimize a standby period for cooling the medium 2 and suppress a productivity reduction.

In addition, with the configuration of the first embodiment, during the fixing operation, the flap 211 is located at the closing position 211a to accelerate the heating of the medium 2 while, when the cutting operation is to be performed, the flap 211 is located at the opening position 211b after the fixing operation to accelerate the cooling of the medium 2. In other words, it is possible to effectively perform the heating and cooling of the medium 2 to improve the productivity, and it is also possible to suppress a cutting failure of the medium 2. Furthermore, since the platen air blowing unit 100 is used to cool the medium 2, it is unnecessary to newly provide an air blowing portion exclusively for medium cooling, and it is also possible to suppress a size increase of the recording apparatus 1.

Note that, in the first embodiment, the fixing unit 200 is configured to be provided with the pivotable flap 211 such that the aperture area in the downstream-side end portion of the fixing unit 200 in the conveyance direction of the medium 2 can be changed, but the fixing unit 200 is not limited to such a configuration. For example, as a means for changing the aperture area, a slidable door may also be provided instead of the flap 211. The door configured to be movable to the closing position where the aperture area is equal to the first area and to the opening position where the aperture area is equal to the second area larger than the first area allows the aperture area in the downstream-side end portion of the fixing unit 200 to be changed, in the same manner as in the first embodiment. Alternatively, it may also be possible to use a configuration in which a plurality of the means for changing the aperture area are provided to allow the aperture area to be changed between three or more levels.

### Second Embodiment

Next, a description will be given of a second embodiment according to the present invention. In the following description, of a configuration of the second embodiment, the same components as those of the first embodiment are denoted by the same reference signs and a description thereof is omitted. A description will be given mainly of characteristic portions of the second embodiment.

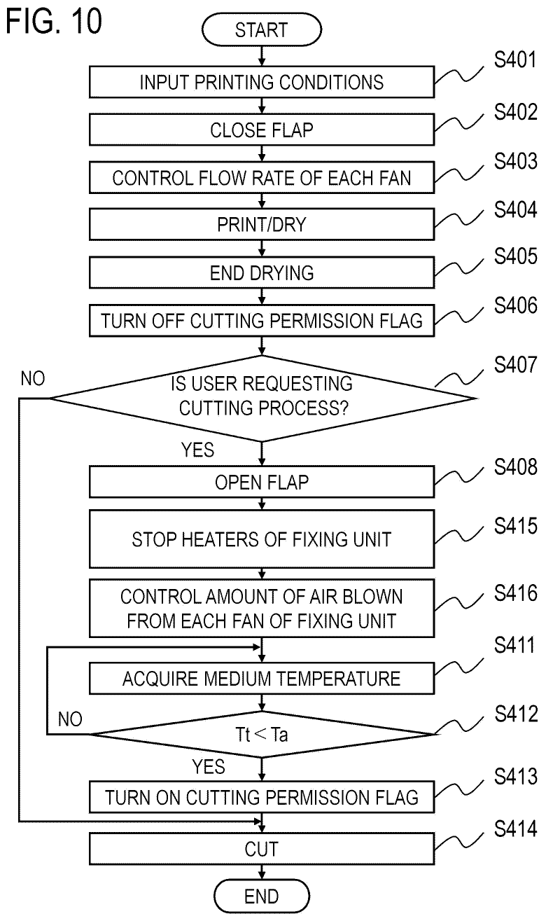

FIG. 10 is a flow chart illustrating a cutting process in the second embodiment. In the second embodiment, the steps in the processing S401 to the processing S408 and the steps in the processing S411 to the processing S414 are the same as those in the first embodiment, and therefore a description thereof is omitted.

In the second embodiment, when the flap 211 moves to the opening position 211b in the processing S408, the present flow advances to processing S415. The processing S415 is a step of stopping the heaters 202 of the fixing unit 200. In the second embodiment, the air blowing fan 101 of the platen air blowing unit 100 continues to be in the ON state, while only the heaters 202 of the fixing unit 200 are stopped, and the fans 201 continue to be in the ON state. In other words, the second embodiment is different from the first embodiment in that, during the cooling of the medium, the fans 201 of the fixing unit 200 continue to be in the ON state.

Processing S416 is a step of controlling an amount of the air blown from each of the fans 201 of the fixing unit 200. In the second embodiment, after the heaters 202 of the fixing unit 200 are stopped, the amount of the air blown from the fan 201 is increased to be larger than that during the fixing operation. Note that, at this time, it may also be possible to simultaneously control the amount of the air blown from the air blowing fan 101 of the platen air blowing unit 100 to be larger than that during the recording operation. Alternatively, it is also possible to increase only the amount of the air blown from the platen air blowing unit 100 without changing the amount of the air blown from the fan 201 of the fixing unit 200. Whether or not to increase the amounts of the air blown from both of the air blowing fan 101 and the fan 201 or the amount of the air blown from either one thereof may be determined appropriately in consideration of the configuration of the recording apparatus 1, efficiency of the cooling of the medium 2, or the like.

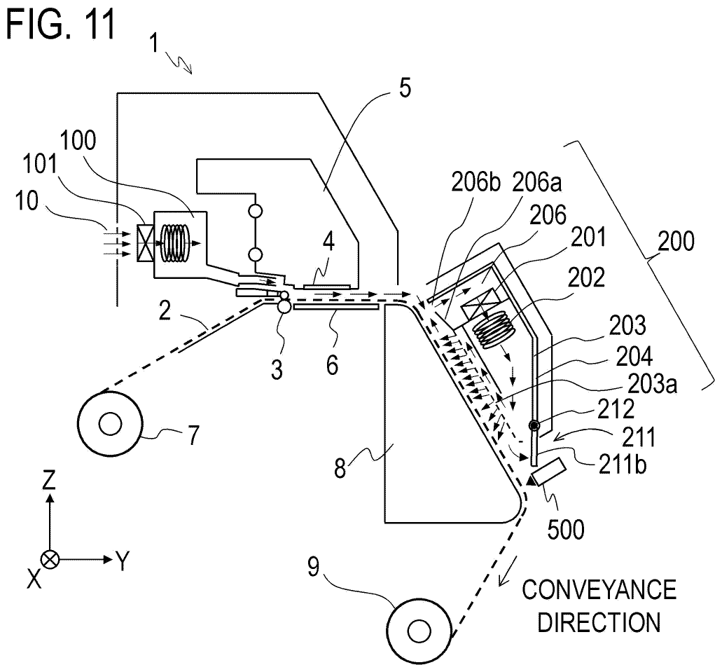

FIG. 11 is a schematic cross-sectional view of the recording apparatus 1 illustrating control of the fan flow rates during the cooling of the medium in the processing S415. In the second embodiment, as illustrated in FIG. 11, by exchanging the hot air in the fixing unit 200 with the outside air 10 retrieved by the air blowing fan 101, cooling in the fixing unit 200 is also performed simultaneously with the cooling of the medium 2. In other words, in the second embodiment, air between the fixing unit 200 and the medium 2 on the paper discharge guide 8 is cooled, while the fixing unit 200 is also cooled to cool the entire atmospheric temperature around the cutter 500. With such a configuration, the temperatures of the fixing unit 200 and a peripheral portion thereof more quickly decrease and, accordingly, after the medium 2 is cut, safety when the user retrieves a deliverable after the cutting from the wind-up roll 9 is improved.

As described above, in the configuration of the second embodiment also, the cutting operation is performed after it is determined whether or not the temperature of the medium 2 is a temperature appropriate for the cutting operation, and therefore it is possible to suppress a cutting failure. In addition, since whether or not the cutting operation can be performed is determined according to the type of the medium 2, by minimizing the standby period for cooling the medium 2, it is possible to suppress a productivity reduction. Furthermore, during the fixing operation, the flap 211 is located at the closing position 211a to accelerate the heating of the medium 2 and, when the cutting operation is to be performed, after the fixing operation, the flap 211 is located at the opening position 211b to accelerate the cooling of the medium 2. In other words, it is possible to effectively perform the heating and cooling of the medium 2, improve the productivity, and also suppress a cutting failure of the medium 2.

Note that, in applying the present invention, the present invention need not necessarily be configured so as to satisfy all of the configurations of the individual embodiments described above. In addition, in applying the present invention, processing described above in each of the embodiments as being performed by one apparatus may also be shared and executed by a plurality of apparatuses.

Alternatively, processing described as being performed by different apparatuses may also be executed by one apparatus. In a computer systema, a type of a hardware configuration that implements each of functions is flexibly changeable.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-212794, filed on Dec. 18, 2023, which is hereby incorporated by reference herein in its entirety.

What is claimed is:

1. A recording apparatus comprising:
a conveying portion that conveys a recording medium in a conveyance direction;
a recording portion that ejects a liquid onto a recording surface of the recording medium to record an image;
a fixing portion disposed on a downstream side of the recording portion in the conveyance direction to heat and fix the image onto the recording surface;
a cutting portion disposed on the downstream side of the fixing portion in the conveyance direction to cut the recording medium;
an air blowing portion that blows air from an upstream side to the downstream side in the conveyance direction and toward the recording surface of the recording medium; and
a control portion that controls an amount of the air from the air blowing portion, the control portion controlling an amount of the air blown from the air blowing portion per unit time after a fixing of the image by the fixing portion is ended till a cutting operation performed by the cutting portion to be larger than an amount of the air blown from the air blowing portion per unit time during a recording operation performed by the recording portion.

2. A recording apparatus comprising:
a conveying portion that conveys a recording medium in a conveyance direction;
a recording portion that ejects a liquid onto a recording surface of the recording medium to record an image;
a fixing portion disposed on a downstream side of the recording portion in the conveyance direction to heat and fix the image onto the recording surface, the fixing portion having an opening through which the recording medium after a fixing of the image thereto is ended is to pass;
a cutting portion disposed on the downstream side of the fixing portion in the conveyance direction to cut the recording medium;
an air blowing portion that blows air from an upstream side to the downstream side in the conveyance direction and toward the recording surface of the recording medium; and
a control portion that controls an amount of the air from the air blowing portion,
wherein an aperture area of the opening of the fixing portion is equal to a first area during the fixing of the image and is equal to a second area larger than the first area during a period after the fixing of the image is ended till a cutting operation performed by the cutting portion.

3. The recording apparatus according to claim 1,
wherein the control portion controls an amount of the air blown from the air blowing portion per unit time after an upstream end of the image in the conveyance direction reaches a downstream end of the fixing portion in the conveyance direction till the cutting operation performed by the cutting portion to be larger than an amount of the air blown from the air blowing portion per unit time during the recording operation performed by the recording portion.

4. The recording apparatus according to claim 2,
wherein, during a period after an upstream end of the image in the conveyance direction reaches a downstream end of the fixing portion in the conveyance direction till the cutting operation performed by the cutting portion, the aperture area of the opening is equal to the second area larger than the first area.

5. The recording apparatus according to claim 1,
wherein the air blowing portion blows the air from the upstream side in the conveyance direction toward the recording portion and
wherein the recording apparatus is formed with a flow path in which the air flows from the recording portion to the cutting portion along the conveyance direction.

6. The recording apparatus according to claim 1,
wherein the air blowing portion blows air retrieved from outside the recording apparatus toward the recording surface.

7. The recording apparatus according to claim 1,
wherein the fixing portion has a fan and a heating source that heats air blown from the fan and
wherein the control portion controls an amount of the air from the fan of the fixing portion.

8. The recording apparatus according to claim 7,
wherein the control portion stops the fan and the heating source of the fixing portion during a period after the fixing of the image is ended till the cutting operation.

9. The recording apparatus according to claim 7,
wherein the control portion stops the heating source during a period after the fixing of the image is ended till the cutting operation, while continuously driving the fan.

10. The recording apparatus according to claim 1,
wherein the cutting portion has a blade configured to be able to perform scanning in a direction crossing the conveyance direction.

11. The recording apparatus according to claim 1,
wherein the fixing portion has an opening through which the recording medium after the fixing of the image thereto is ended is to pass and
wherein an aperture area of the opening of the fixing portion is equal to a first area during the fixing of the image and is equal to a second area larger than the first area during a period after the fixing of the image is ended till the cutting operation.

12. The recording apparatus according to claim 11,
wherein the fixing portion has a moving member configured to be movable to a first position where the aperture area is equal to the first area and to a second position where the aperture area is equal to the second area.

13. The recording apparatus according to claim 12,
wherein the moving member is a flap configured to be pivotable between the first position and the second position around a center axis extending in a width direction of the recording medium conveyed by the conveying portion.

14. The recording apparatus according to claim 1, further comprising:
a feeding portion located on the upstream side of the recording portion in the conveyance direction to allow the recording medium to be wound therearound into a roll shape and feed the recording medium; and
a wind-up portion located on the downstream side of the cutting portion in the conveyance direction to allow the recording medium to be wound therearound into a roll shape and wind up the recording medium.

15. The recording apparatus according to claim 1, further comprising:
a temperature acquiring means that acquires a temperature of the recording medium; and
a determining means that determines whether or not the temperature of the recording medium acquired by the temperature acquiring means is a temperature appropriate for the cutting of the recording medium.

16. The recording apparatus according to claim 15,
wherein the cutting portion is driven on the basis of a result of a determination by the determining means.

17. The recording apparatus according to claim 15,
wherein the temperature acquiring means acquires the temperature of the recording medium on the basis of at least one of a temperature inside the fixing portion during the fixing of the image, a temperature in an environment in which the recording apparatus is placed, and a coefficient of a speed of cooling of the recording medium.

18. The recording apparatus according to claim 2,
wherein the air blowing portion blows the air from the upstream side in the conveyance direction toward the recording portion and
wherein the recording apparatus is formed with a flow path in which the air flows from the recording portion to the cutting portion along the conveyance direction.

19. The recording apparatus according to claim 2,
wherein the air blowing portion blows air retrieved from outside the recording apparatus toward the recording surface.

20. The recording apparatus according to claim 2,
wherein the fixing portion has a fan and a heating source that heats air blown from the fan and
wherein the control portion controls an amount of the air from the fan of the fixing portion.

21. The recording apparatus according to claim 20,
wherein the control portion stops the fan and the heating source of the fixing portion during a period after the fixing of the image is ended till the cutting operation.

22. The recording apparatus according to claim 20,
wherein the control portion stops the heating source during a period after the fixing of the image is ended till the cutting operation, while continuously driving the fan.

23. The recording apparatus according to claim 2,
wherein the cutting portion has a blade configured to be able to perform scanning in a direction crossing the conveyance direction.

24. The recording apparatus according to claim 2,
wherein the fixing portion has a moving member configured to be movable to a first position where the aperture area is equal to the first area and to a second position where the aperture area is equal to the second area.

25. The recording apparatus according to claim 24,
wherein the moving member is a flap configured to be pivotable between the first position and the second position around a center axis extending in a width direction of the recording medium conveyed by the conveying portion.

26. The recording apparatus according to claim 2, further comprising:
a feeding portion located on the upstream side of the recording portion in the conveyance direction to allow the recording medium to be wound therearound into a roll shape and feed the recording medium; and
a wind-up portion located on the downstream side of the cutting portion in the conveyance direction to allow the recording medium to be wound therearound into a roll shape and wind up the recording medium.

27. The recording apparatus according to claim 2, further comprising:
a temperature acquiring means that acquires a temperature of the recording medium; and
a determining means that determines whether or not the temperature of the recording medium acquired by the temperature acquiring means is a temperature appropriate for the cutting of the recording medium.

28. The recording apparatus according to claim 27,
wherein the cutting portion is driven on the basis of a result of a determination by the determining means.

29. The recording apparatus according to claim 27,
wherein the temperature acquiring means acquires the temperature of the recording medium on the basis of at least one of a temperature inside the fixing portion during the fixing of the image, a temperature in an environment in which the recording apparatus is placed, and a coefficient of a speed of cooling of the recording medium.
